(19) United States
(12) Patent Application Publication
(10) Pub. No.: US 2025/0293728 A1
(43) Pub. Date: Sep. 18, 2025

(54) BEAM STEERING IN RECONFIGURABLE SURFACES UTILIZING INTEGRATED ACTUATORS

(71) Applicant: Dell Products L.P., Round Rock, TX (US)

(72) Inventors: Tejinder Singh, Kanata (CA); Navjot Kaur Khaira, Kanata (CA)

(21) Appl. No.: 18/604,674

(22) Filed: Mar. 14, 2024

(51) Int. Cl. H04B 7/04; H01Q 3/12; H01Q 15/00

(52) U.S. Cl. CPC H04B 7/04013; H01Q 3/12; H01Q 15/0086

(57) ABSTRACT

The technology described herein is directed towards a reconfigurable surface device that reflects an impinging electromagnetic signal, with a phase profile determined by vertical positioning of a flexible metallic ground plane beneath metallic resonating elements of the reconfigurable surface. The vertical positioning forms different gaps between portions of the flexible ground plane and the respective metallic resonating elements above those portions, to determine the direction of the reflected beam. In one implementation, four individually linear actuators (vertical driving motors) are mechanically coupled to the corners of the ground plane of a metasurface (panel). These actuators and motors are independently controlled to establish the phase profile, by determining the amount of vertical positioning of each corner of the flexible ground plane to steer the reflected beam. The low-cost design can operate to steer millimeter wavelength beams in many wireless communication scenarios.

### BACKGROUND

Reconfigurable intelligent surfaces, sometimes referred to as metasurfaces, redirect (e.g., reflect or refract) incoming electromagnetic beams in a fixed direction, by modifying the resultant beams in terms of phase, amplitude, and polarization. As such, reconfigurable surfaces are being investigated for use in the millimeter wave (mmWave) spectrum, where reflected beams can avoid obstacles that otherwise block a signal between a transmitter (e.g., a base station) and a receiver (e.g., a user equipment).

### BRIEF DESCRIPTION OF THE DRAWINGS

The technology described herein is illustrated by way of example and not limited in the accompanying figures in which like reference numerals indicate similar elements and in which:

FIG. 1 is an example conceptual block diagram showing a reconfigurable surface (metasurface) in which vertical motion actuators (e.g., motors) curve and/or vertically move a ground plane to achieve analog and dynamic beam steering of a reflected electromagnetic signal, in accordance with various example embodiments and implementations of the subject disclosure.

FIG. 2A is a perspective view of an example unit cell of a reconfigurable surface showing the concept of a variable air gap/buffer, in accordance with various example embodiments and implementations of the subject disclosure.

FIG. 2B is an example side view of an example unit cell of a reconfigurable surface with a variable gap, in accordance with various example embodiments and implementations of the subject disclosure.

FIGS. 3A-3D are example representations of different air cavity thickness (gaps) separating a substrate of a unit cell from a corresponding portion of the flexible metallic ground plane as the flexible ground plane is vertically moved in different amounts to achieve reconfigurability in the reflected signal, in accordance with various example embodiments and implementations of the subject disclosure.

FIG. 4 is an example graph showing reflection phase that is tuned by changing the air cavity thicknesses for a forty gigahertz (40 GHz) frequency, in accordance with various example embodiments and implementations of the subject disclosure.

FIG. 5 is an example graph showing reflection magnitude that is tuned by changing the air cavity thicknesses for a 40 GHz frequency, in accordance with various example embodiments and implementations of the subject disclosure.

FIG. 6 is an example graph showing reflection phase that is tuned by changing the air cavity thicknesses for a twenty-eight gigahertz (28 GHz) frequency, in accordance with various example embodiments and implementations of the subject disclosure.

FIG. 7 is an example graph showing reflection magnitude that is tuned by changing the air cavity thicknesses for a 28 GHz gigahertz frequency, in accordance with various example embodiments and implementations of the subject disclosure.

FIG. 8 is a top view of an example reconfigurable surface of unit cells arranged in a two-dimensional array, along with an enlarged perspective view of one of the unit cells, in accordance with various example embodiments and implementations of the subject disclosure.

FIG. 9 is a representation of an example gradient phase profile overlaid on a designed reflective surface, in accordance with various example embodiments and implementations of the subject disclosure.

FIG. 10 is an isometric full section view of an example reconfigurable surface including components within a housing, in accordance with various example embodiments and implementations of the subject disclosure.

FIG. 11 is a sectional view (based on the cut-plane A-A′ of FIG. 10) of the example reconfigurable surface including components within a housing, in accordance with various example embodiments and implementations of the subject disclosure.

FIG. 12 is a back side view of the example reconfigurable surface housing showing perforations to reduce air damping, in accordance with various example embodiments and implementations of the subject disclosure.

FIG. 13 is a two-dimensional cross-sectional view of an example reconfigurable surface (moveable metal sheet) including components within a housing, and vertical movement of a flexible ground plane to an uppermost vertical position (minimum air gap), in accordance with various example embodiments and implementations of the subject disclosure.

FIG. 14 is a two-dimensional cross-sectional view of an example reconfigurable surface (moveable metal sheet) including components within a housing, and vertical movement of a flexible ground plane to a tilted position, in accordance with various example embodiments and implementations of the subject disclosure.

FIG. 15 is a two-dimensional cross-sectional view of an example reconfigurable surface (moveable metal sheet) including components within a housing, and vertical movement of a flexible ground plane to a different tilted position (relative to FIG. 14), in accordance with various example embodiments and implementations of the subject disclosure.

FIG. 16 is a two-dimensional cross-sectional view of an example reconfigurable surface including a tuning mechanism and parts of the reflective metasurface, showing a moveable metal ground plane in a first position, along with a top view representation of the moveable plane and corresponding actuator biases, in accordance with various example embodiments and implementations of the subject disclosure.

FIG. 17 is a two-dimensional cross-sectional view of an example reconfigurable surface including a tuning mechanism and parts of the reflective metasurface, showing a moveable metal ground plane in a second (moderately angled) position, along with a top view representation of the moveable plane and corresponding actuator biases, in accordance with various example embodiments and implementations of the subject disclosure.

FIG. 18 is a two-dimensional cross-sectional view of an example reconfigurable surface including a tuning mechanism and parts of the reflective metasurface, showing a moveable metal ground plane in a third (more steeply angled) position, along with a top view representation of the moveable plane and corresponding actuator biases, in accordance with various example embodiments and implementations of the subject disclosure.

FIGS. 19A-19D are top view representations of a moveable plane showing various gradient profiles achieved by actuating different corner actuators to move the ground plane different vertical amounts, providing different deflections in the ground plane, in accordance with various example embodiments and implementations of the subject disclosure.

FIGS. 20A-20D are top view representations of a moveable plane showing various gradient profiles achieved by actuating different corner actuators to move the ground plane different vertical amounts, providing different deflections in the ground plane, in accordance with various example embodiments and implementations of the subject disclosure.

FIG. 21 is a representation of an example incident electromagnetic beam from a horn antenna being steered in a desired direction by changing the air gap distances between the metallic elements of the unit cells and the ground plane of a reconfigurable surface, in accordance with various example embodiments and implementations of the subject disclosure.

FIGS. 22A and 22B are representations of different reflected beam directions controlled by changing the air gap distances between the metallic elements of the unit cells and the ground plane of a reconfigurable surface, in accordance with various example embodiments and implementations of the subject disclosure.

FIG. 23 is a flow diagram showing example operations related to driving groups of actuators to vertically move a ground plane based on phase profile data, in accordance with various example embodiments and implementations of the subject disclosure.

### DETAILED DESCRIPTION

The technology described herein is generally directed towards low-cost beam steering using reflective metasurfaces (reconfigurable surfaces) that are coupled to mechanical linear actuators. The technology described herein is based on advanced metasurfaces with analog-style beam steering capabilities, which dynamically and accurately manipulate reflected signal beam directions.

As mentioned in the background, reconfigurable intelligent surfaces, or metasurfaces, can be used to redirect, e.g., reflect or refract, incoming electromagnetic beams in a fixed direction, by modifying the resultant beams in terms of phase, amplitude, and polarization. In this regard, some current electronically tunable designs for metasurfaces depend on PIN diodes and/or varactors acting as switches between metallic patterns. Commonly available PIN diodes and varactors have a number of problems, however, including low maximum operating frequencies and other frequency-dependent characteristics such as narrow bandwidth, which limits their use at mm Wave frequencies. PIN diodes and varactors offer high losses and parasitic effects that are particularly severe at mmWave frequencies, which is not desirable for high frequency performance. Further, there is only limited reconfigurability achieved using PIN diodes and varactors at mmWave operational range; for example, PIN diodes offer only either ON or OFF states, whereby only two reconfigurable states of phase are possible from using a single PIN diode in a metasurface. Still further, on-chip components like varactors/PIN diodes need to be soldered in each reconfigurable intelligent surface element. For low frequencies, when the individual cell size is large, this approach can still be employed, however at mmWave frequencies (30-300 GHz), soldering becomes a challenge with the shrinking cell size, making the device performance highly sensitive to the type and quality of the assembly and packaging process.

Current metasurfaces based on PIN diodes and varactors are also expensive. For example, in one metasurface of unit cells, for bias control each unit cell needs eight varactors and one operational amplifier (op-amp) integrated circuit to provide the desired voltage gain to actuate the varactors. Hence, for an 8×8 array, 512 varactors and 64 op-amps are required. For larger RIS arrays, the complexity of bias control will scale multifold.

Accordingly, in one example embodiment, four individually controllable linear actuators are mechanically coupled to the corners of a ground plane of a metasurface (panel). These four actuators, such as Piezo motors, enable varying phase profiles, by determining the tilt and/or curvature (flex) of a flexible/moveable metallic ground plane, which allows a reflected beam to be steered. To this end, the individually controllable linear actuators can independently move the corners of the moveable metallic ground plane vertically up or down, which determines the tilt and/or some amount of curve of at least part of the flexible, metallic ground plane, which allows the reflected beam to be steered in a desired direction. This example implementation facilitates a scalable beam steering device for reconfigurable metasurfaces, using mechanical tuning with only four linear actuators (e.g., four piezo motors), regardless of panel size and/or number of unit-cells.

The technology described herein is based on an air cavity formed between a periodic resonating metallic surface on a dielectric substrate and a floating ground plane made using a flexible thin metal sheet. By employing linear motion actuators that support and provide vertical force to the flexible thin metal sheet, e.g., vertically up or down at each of its four corners, the amount of curvature and/or tilt angle of the metal sheet is adjustable, which can significantly alter the reflection phase response, including at mmWave operational frequencies, such as at or around 28 GHz to 40 GHz. This curvature and tilt angle alteration is driven by the actuators' precision movement, in which the vertical driving actuators (e.g., Piezo motors) can influence the amount of curve, and/or determine a tilt angle of all (or at least part of) the metal sheet. The amount of curvature and/or tilt angle of the flexible sheet determines the phase reflection, which is dependent on the variable distances (e.g., heights if positioned vertically) of the air gaps. Leveraging the linear motion actuators and providing bias to the actuators offers a gradient phase profile to the entire metasurface array, facilitating precision-tuning of the reflection characteristics, which results in controllable beam steering.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and reconfigurable intelligent surfaces in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

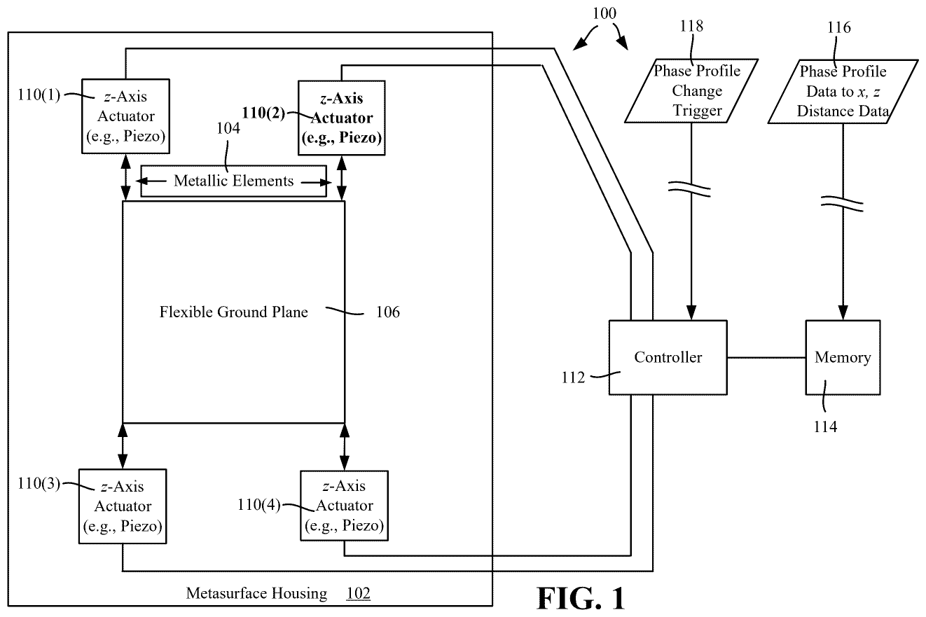

FIG. 1 is a conceptual block depiction of an example system 100 including a metasurface housing 102, which, via metallic elements 104 and a flexible ground plane 106, reflects an impinging (incoming) signal, (an electromagnetic (EM)/radio frequency (RF) wave, such as near or within the millimeter wavelength, e.g., above 25 gigahertz). In one implementation, four linear actuators 110(1)-110(4), sometimes referred to herein as (e.g., piezo) motors, are mechanically coupled to the corners of the flexible ground plane 106 to raise or lower any or all of the corners of the flexible ground plane 106 a desired vertical distance relative to the metallic elements 104, thus raising or lowering one or more of the corners (or the entire flexible ground plane 106). This can establish a desired tilt angle and/or influence an amount of curve. The linear actuators 110(1)-110(4) can thus raise or lower any corner of the flexible ground plane 106 in a way that changes the phase profile of the reconfigurable surface, resulting in beam steering of the reflected signal. Indeed, the flexible sheet can be curved and/or tilted in part or as a whole, e.g., left-to-right, front-to-back, or a combination of both, relative to the metallic elements 104. Vertical movement, e.g., in unequal vertical amounts at the corners, can additionally change the curve to an extent of what starts as an otherwise straight (non-flexed) flexible ground plane 106. As will be understood, upward or downward movement of the motors 110(1)-110(4) changes the distances between portions of the flexible ground plane 106 and the metallic elements to a desired amount, resulting in differences in distances (gaps) between individual portions of the ground plane 106 and individual resonating metallic patterns of the metallic elements 104 based on vertical-driven motion. Tilt and/or curvature resulting from operating the motors 110(1)-110(4) thus can be controlled to obtain a phase profile that results in desired beam steering.

In one or more example implementations, a controller 112 is configured to drive the linear actuators 110(1)-110(4) a desired distance (e.g., in what can be considered a +Z or −Z direction from the perspective of the motors), to determine the height and/or tilt (and/or flex location or locations) of the flexible ground plane 106. Electrical driving circuits or the like (not explicitly shown) can be used as needed to provide sufficient power to the linear actuators 110(1) 110(4), e.g., for a controller that outputs only low voltage/low current signals that thus indirectly drive the linear actuators 110(1)-110(4).

The controller 112 can be coupled to a memory 114 that contains the phase profile data (e.g., including the actuators'/motors' ±Z distances) needed to curve, raise or lower, and/or tilt the flexible ground plane 106 the desired amount that results in a desired phase profile for the reflected beam. Multiple sets of phase profile data/actuator vertical distances, such as arranged in lookup tables, may be written or downloaded to (e.g., block 116) and/or maintained in the memory 114 as needed, and a suitable phase profile trigger (e.g., block 118) can be used to instruct the controller 112 as to which set of phase profile data to use to correspondingly drive the linear actuators 110(1)-110(4) to steer the reflected beam. The direction of the reflected beam thus may be dynamically re-steered in a relatively fast manner, based only on how fast the actuators can move and/or flex the flexible ground plane 106 to the specified phase profile data's vertical height amounts.

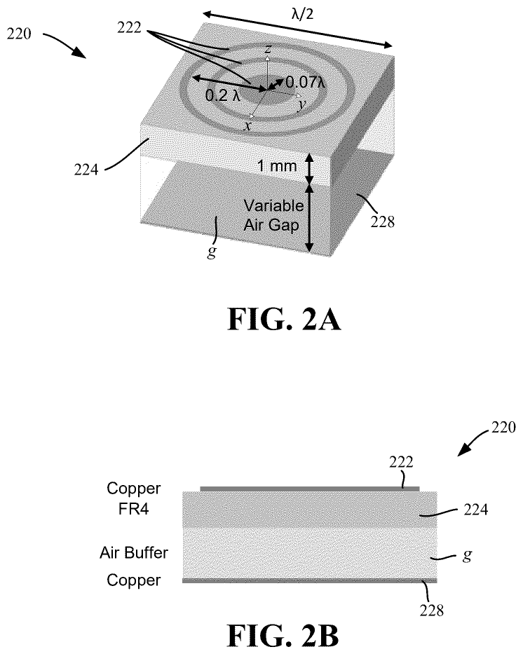

In general, a reflective metasurface is formed by a two-dimensional periodic array of unit cells. An example unit-cell structure 220 is shown in FIGS. 2A and 2B. In this depicted example embodiment, metallic concentric circular loops 222 are printed on a substrate 224, e.g., a 1.0 mm thick FR4 substrate. The substrate 224 is placed over a ground plane portion 228 (the ground plane's portion/area directly beneath the circular loops 222) forming an air cavity/buffer having a variable distance, or gap g as labeled in FIGS. 2A and 2B. The reflection phase response of the structure is dependent on the cavity thickness, which leads to a significant tuning range. As will be understood, the variable distance can be mechanically adjusted to modulate the reflection phase response of a reflected signal.

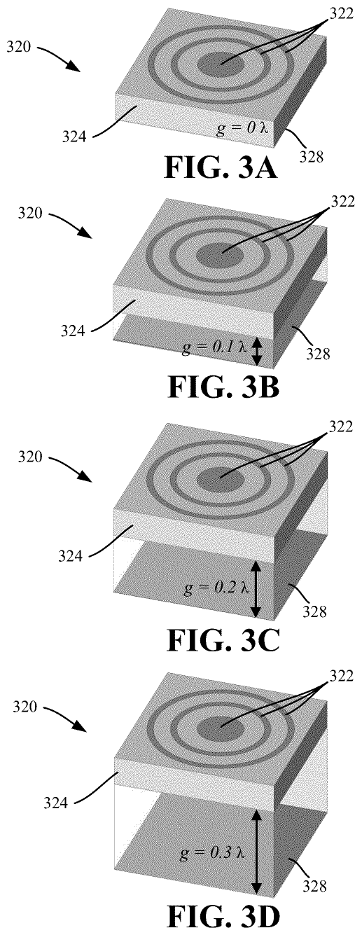

FIGS. 3A-3D show examples of the variable gap of a unit cell 320, which can be tuned to achieve the achieve the reconfigurability in the reflected phase. For any unit cell, the gap's distance g is based on the curvature, height and/or tilt of the flexible ground plane (which can be different in each ground plane portion below each unit cell) relative to the resonating metallic concentric circular loops 322/the substrate 324. The reflection phase response of the structure is strongly dependent on the cavity thickness, which leads to a significant tuning range for beam steering. The air cavity thickness gap g separating the substrate, and the flexible metallic bottom sheet (ground plane) 328 is controllably movable, based on vertical positioning of the corners of the flexible ground plane 328 to raise, lower, curve and/or tilt the flexible ground plane 328 to achieve the reconfigurability in the reflected signal.

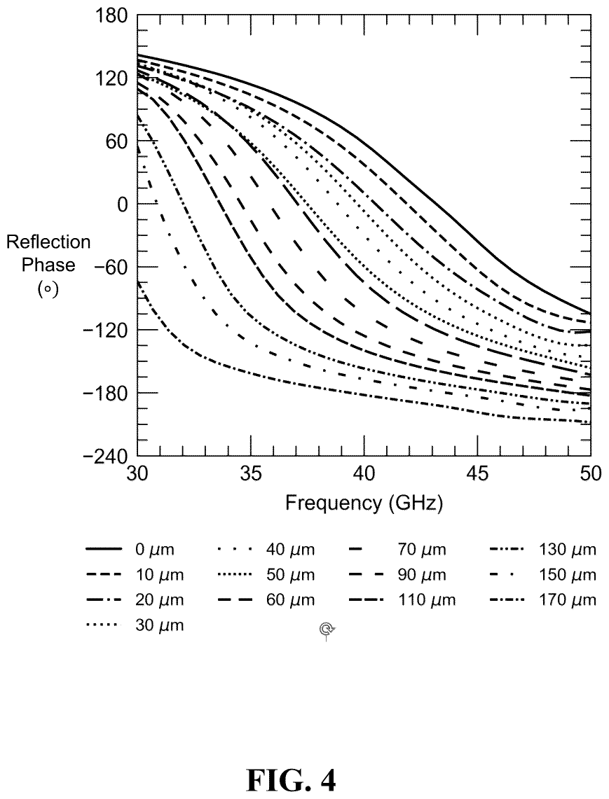

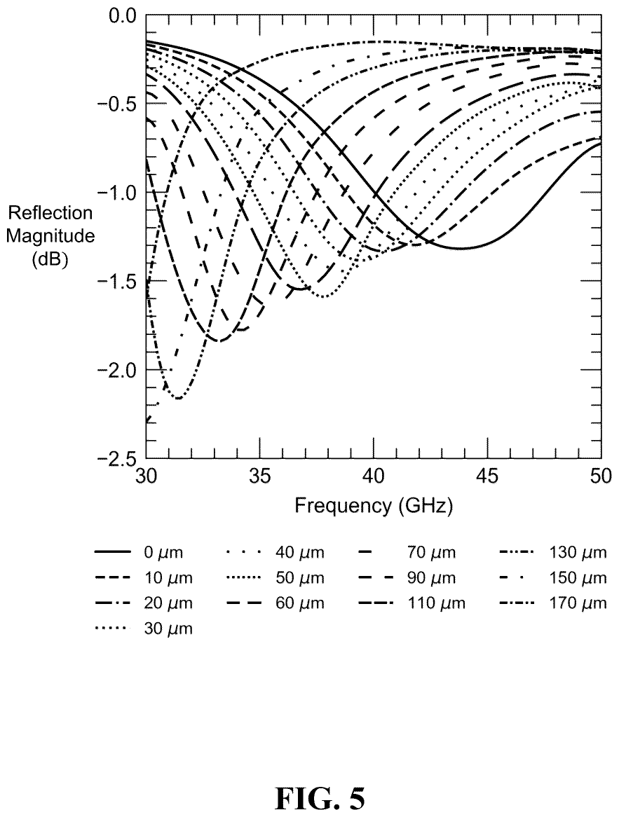

FIGS. 4 and 5 show the reflection phase and magnitude, respectively, tuned by changing the air cavity thickness. More particularly, FIGS. 4 and 5 show the full field 3D EM simulated reflection phase and magnitude, respectively are shown for of a unit cell at 40 GHz for different air cavity thicknesses ranging from 0 μm to 170 μm. As can be seen, significant phase shift is obtained with this design (Δθ=240° for Δt=170 μm), where θ represents the polar elevation angle.

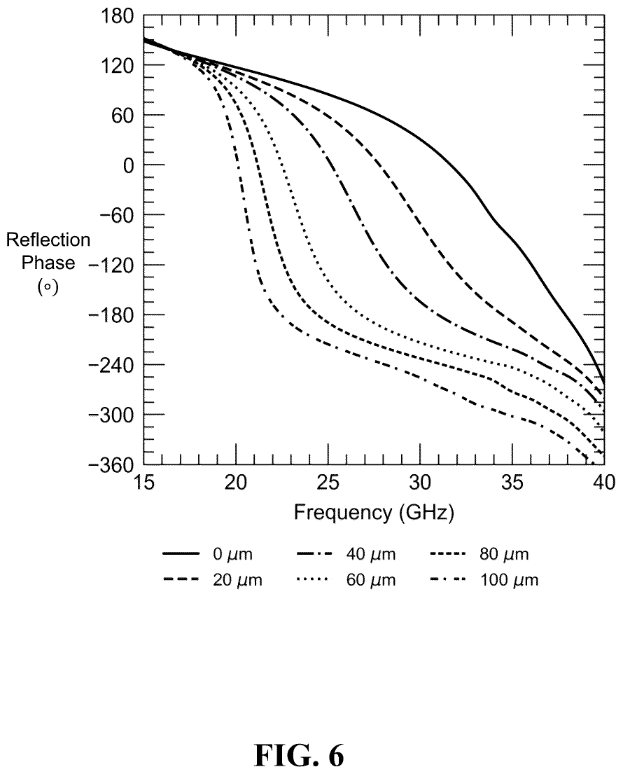

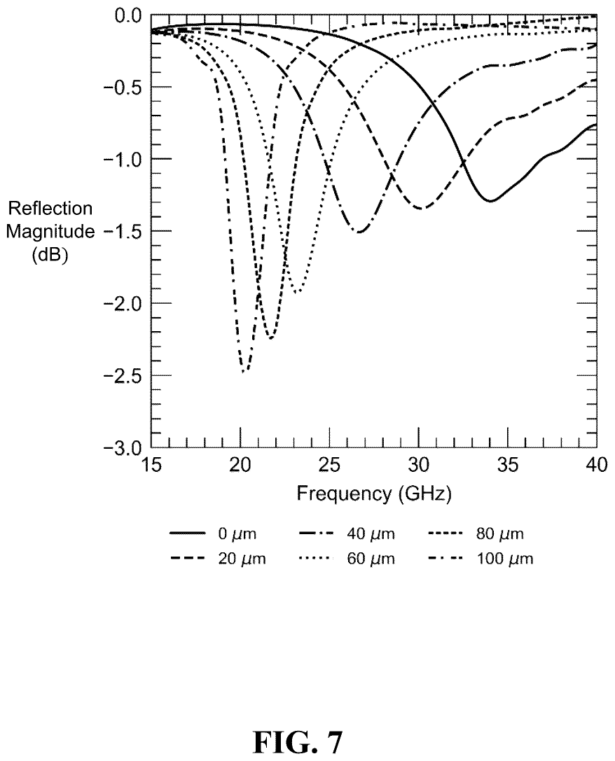

FIGS. 6 and 7 also show the full field 3D EM reflection phase and magnitude, respectively, tuned by changing the air cavity thickness ranging from 0 μm to 100 μm of a unit cell at 28 GHz. For example, with a 100 μm displacement of the ground plane, the achieved tunable reflection phase range is 300° as shown in FIG. 6.

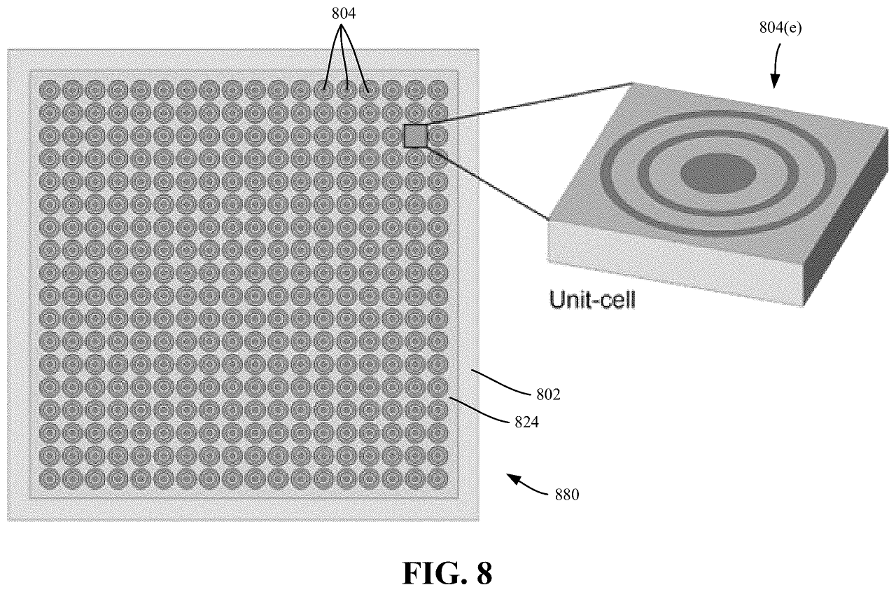

FIG. 8 shows an example reconfigurable surface structure 880 showing unit cells (collectively 804) arranged in a two-dimensional array above a substrate 824, contained within a housing 802. Also shown in FIG. 8 is an enlarged representation 104(e) of one of the unit cells.

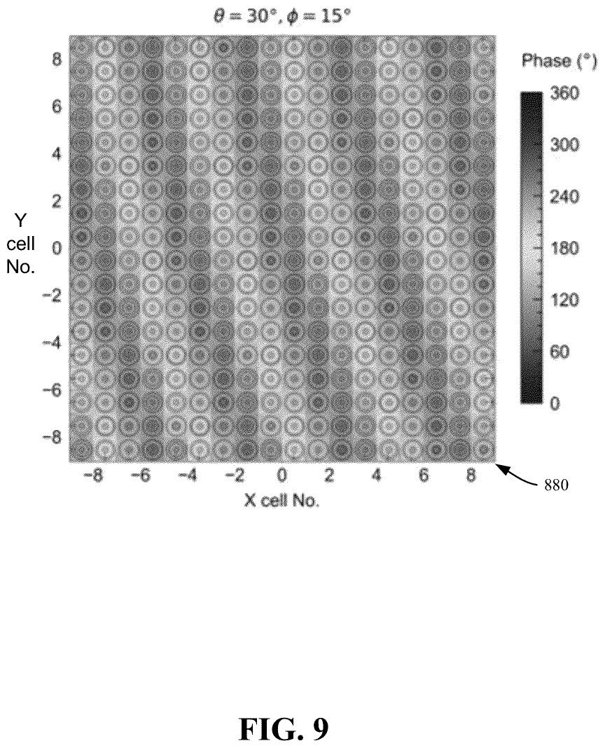

FIG. 9 shows a computed gradient phase profile overlaid on a designed reflective surface 880 for θ=30° and ϕ=15° where ϕ represents the azimuth angle. As can be seen, using a gradient phase profile for dynamically controlled beamforming (beam steering) is desirable and achievable as described herein.

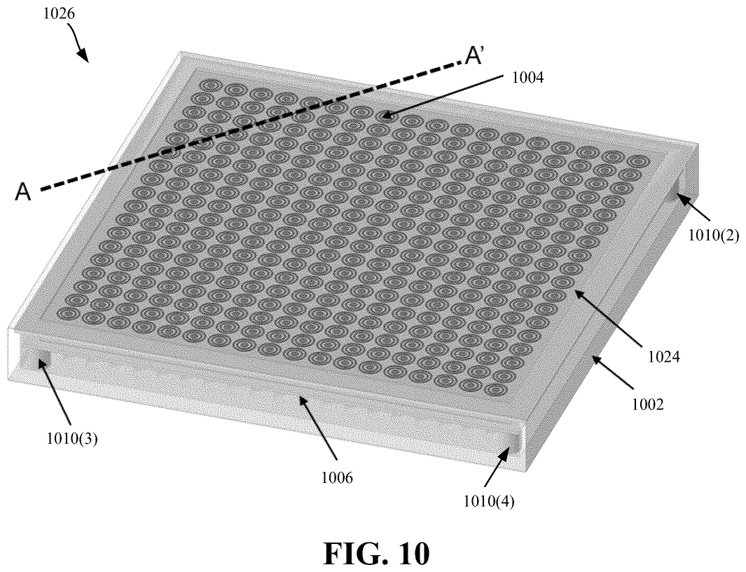

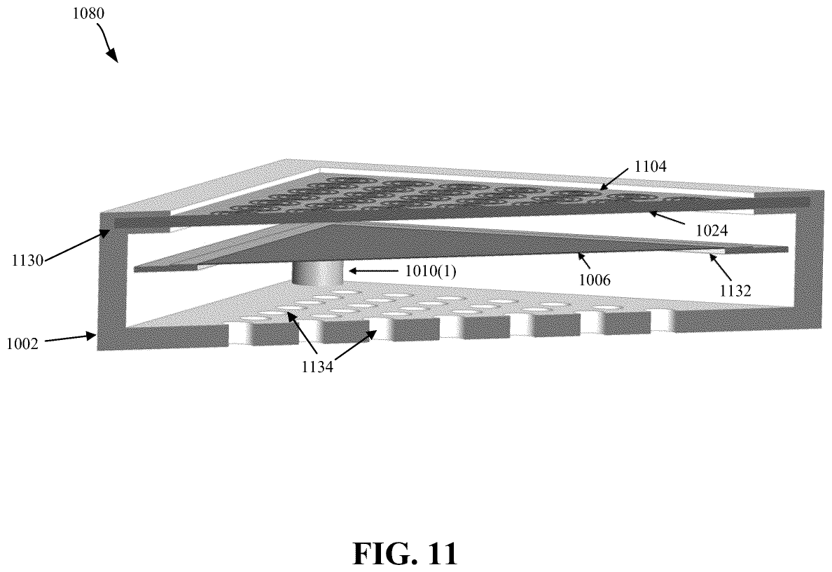

The beam shaping functionality can be incorporated into a complete product, such as shown in FIGS. 10-12. More particularly, FIG. 10 shows a 3D isometric view of a metasurface panel 1026 with housing 1002 and other components, including one labeled metallic element 1004 of the multiple (e.g., 18×18 in this example) unit cells on a substrate 1024. The flexible metal plane 1006 can be moved by the actuators, one vertical actuator in each corner, resulting in the flexible metal plane 1006 being tiltable and/or height adjustable and/or curve-able to an extent, including by motors 1010(2)-1010(4) that are at least partially visible in FIG. 10. A cut plane (A-A′) is highlighted in FIG. 10, to show the interior of the structure (in FIG. 11).

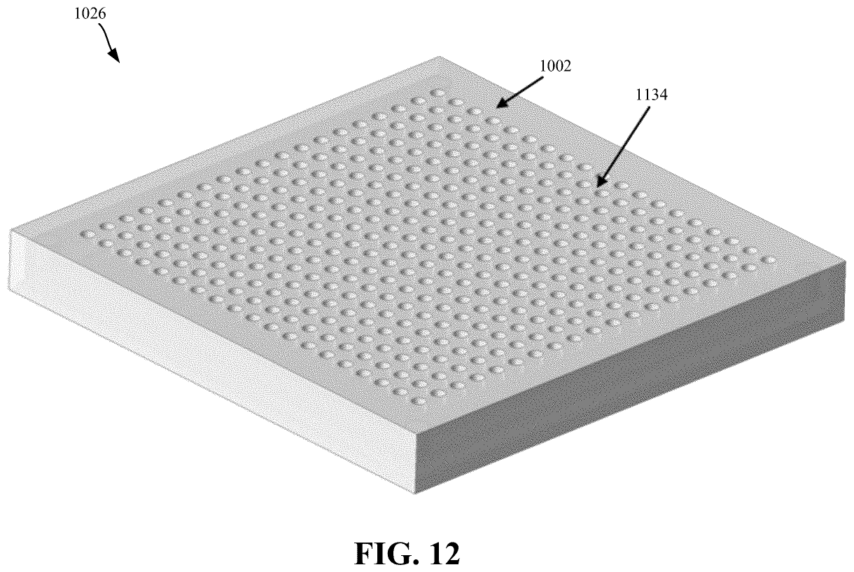

In FIG. 11, the sectional view (corresponding to the cut plane A-A′ of FIG. 10) of the panel 1026 including the housing 1002 is shown with the unit cells (collectively 1104) above the substrate 1024. In FIG. 11, an actuator/motor component 1010(1) is visible. One type of anchor is the substrate support anchor 1130 that supports one of the four corners of the substrate 1024; the other three substrate support anchors are not labeled in this view. Another type of anchor 1132, supported by an (e.g., piezoelectric) actuator/motor component 1010(1), supports the moveable (flexible) ground plane 1006; the other three ground plane anchors are not labeled in this view. FIG. 11 also shows perforations (collectively 1134), which help to avoid any air damping, facilitate heat dissipation, and result in weight reduction of the panel. The reverse side of the panel 1026 is shown in FIG. 12, which highlights these perforations 1134 in the underside of the housing 1002.

The housing 1002 and support structure or anchors (e.g., 1130 and 1132) can be made using various materials, such as TEFLON, ABS, PET, PET-G, plastic and/or any other commonly available RF transparent material. The thickness of the flexible sheet 1006 needs to be thick enough to not allow mechanical breakage or failure, yet thin enough to accommodate the force of the vertical motors including 1010(1) that curve and/or flex the ground plane sheet 1006. A slightly thicker sheet can be used as the panel size increases, to avoid creating a negative sag in the center due to gravity. A simple spring-like structure (not explicitly shown) can be used in the middle of the sheet 1006 to mitigate this concern without increasing any complexity in the design.

In one implementation, piezoelectric actuators are used (which are known for their nanometer precision, ultra-fast response, and affordability) to change the thickness of the air gap at nanometer precision, hence altering the phase response of reflected waves. While numerous varieties of piezoelectric actuators can be utilized in this design, one feasible and effective actuator can be a stacked ceramic disk piezoelectric actuator made of lead (Pb) zirconate (Zr) titanate (Ti), also known as PZT. Each disk in the stack exhibits the characteristic of vertical expansion when an electric potential is applied, a property attributed to the piezoelectric effect. The disks in the stack are divided by slim metallic electrodes which apply the voltage. As a result, a substantial cumulative expansion is possible, equal to the sum of the expansions of each individual disk. In any event, one suitable commercially available vertical motor/actuator is a PI N-412 piezo motor actuator. By providing individual biasing to only four corner vertical actuators attached to the floating ground plane 1006, an analog-type tuning approach is enabled, creating a gradient phase profile across the entire metasurface array for enhanced reconfigurability and beamforming.

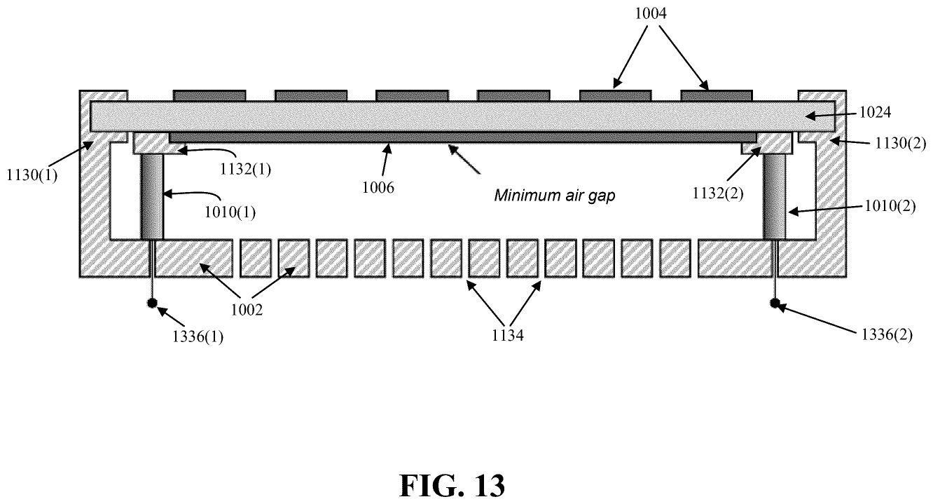

FIGS. 13-15 are example cross-sectional 2D/front view representations directed to vertical movement via the motors 1010(1)-1010(4), (of which the motors 1010(1) and 1010(2) are visible. In FIGS. 13-15, the labeled components include the housing 1002, the metallic elements 1004, the flexible and moveable ground plane sheet 1006, the substrate 1024 and the perforations 1134. Two of the four substrate supports 1130(1) and 1130(2) are shown, as are two of the four flexible ground plane sheet support anchors 1132(1) and 1332(2). FIGS. 13-15 also highlight/show two of the four linear actuators 1010(1) and 1010(2) are controllable to determine vertical positions of the ground plane's corners via control terminals 1336(1) and 1336(2) for the linear actuators.

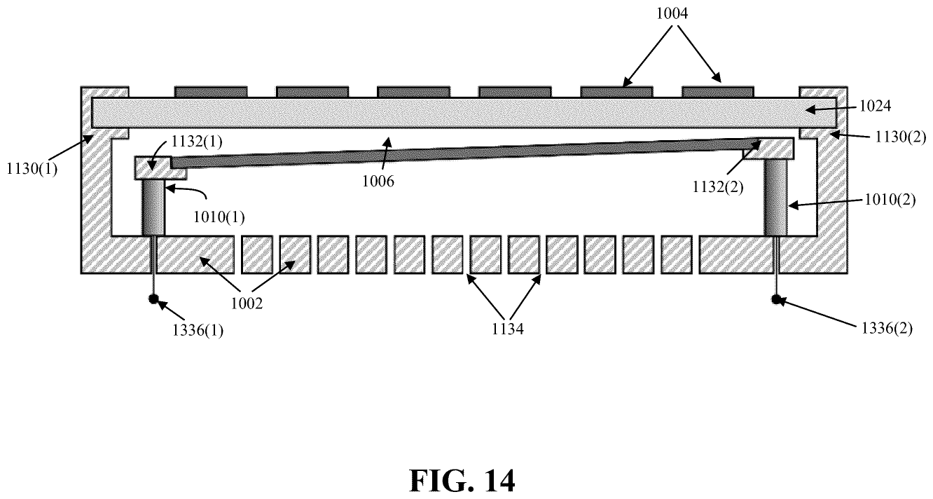

In the example of FIG. 13, the motors 1132(1) and 1132(2) have been controlled to raise the flexible and moveable ground plane sheet 1006 to its uppermost position, corresponding to a minimum possible air gap across the entire metasurface. In FIG. 14, the left motor 1010(1) (or two left motors, of which only the left motor 1010(1) is shown) has lowered the flexible and moveable ground plane sheet 1006 in the −Z direction such that the right side of the flexible and moveable ground plane sheet 1006 is higher than the left side, such as by driving the left-side motor(s) downwardly relative to the right side motor(s) 1010(2). Depending on the prior tilt angle, if any, the right motor 1010(2) (or two right motors, of which only the right motor 1010(2) is shown) may have moved the right side upward (in the +Z direction) or downward (in the −Z direction) relative to the left side. Note that all motors may be controlled to achieve the tilt angle depicted in FIG. 14. Further note that although not depicted in FIG. 14, the tilt angle also may include an amount of tilt from forward to back.

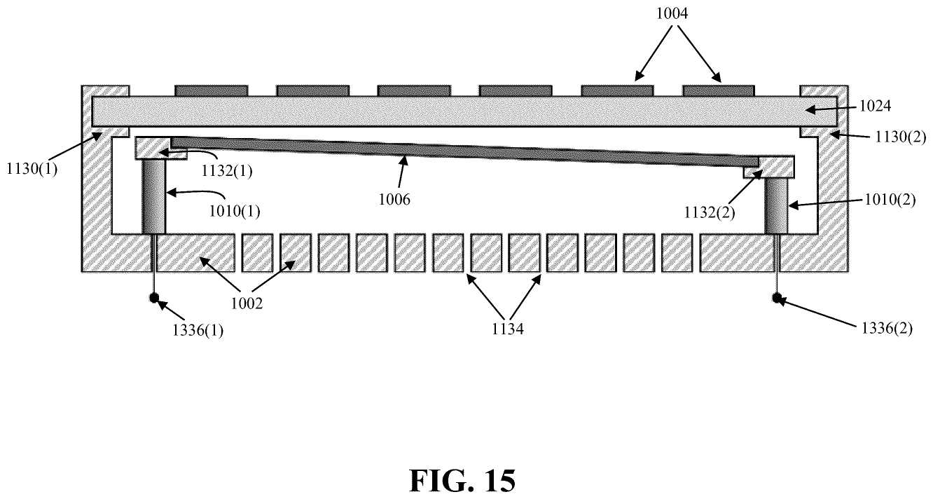

FIG. 15 shows the opposite tilt angle (relative to FIG. 14) of the ground plane 1006. In FIG. 15, the left motor 1010(1) (or two left motors, of which only the left motor 1010(1) is shown) has raised the flexible and moveable ground plane sheet 1006 in the +Z direction such that the left side of the flexible and moveable ground plane sheet 1006 is higher than the right side, such as by driving the left-side motor(s) upwardly relative to the right side motor(s) 1010(2). Depending on the prior tilt angle, if any, the right motor 1010(2) (or two right motors, of which only the right motor 1010(2) is shown) may have moved the right side upward (in the +Z direction) or downward (in the −Z direction) relative to the left side.

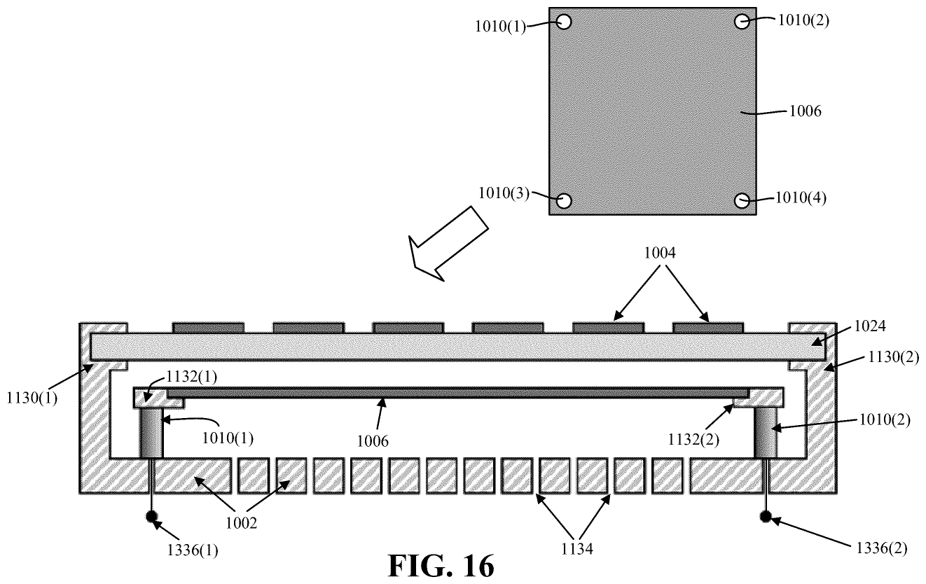

Three different tuning configurations are shown in the example cross-sectional 2D/front view representations of FIGS. 16-18, with corresponding top-view gradient profiles shown in the upper right corners of each of FIGS. 16-18. In the top-view gradient profiles FIGS. 16-18, high bias (e.g., corresponding to an “up” state) is represented by a dark shaded dot at zero or more of the corners of the flexible and moveable ground plane sheet 1006, medium bias (e.g., corresponding to a “middle” state) is represented by a lightly-shaded dot at zero or more of the corners of the flexible and moveable ground plane sheet 1006, and zero (or very low) bias (e.g., corresponding to a “down” state) is represented by an unshaded dot at zero or more of the corners of the flexible and moveable ground plane sheet 1006.

In FIG. 16, all four actuators are in the down state (unshaded dots in the top view portion), e.g., no voltage or bias is provided, and there is a maximum gap between the ground plane 1106 and the top substrate 1024. This moderate tilt angle generates a flat profile with no gradient and does not provide any beamforming; the reflected beam will be either normal to the surface or in a pre-defined direction, depending on the metasurface pattern.

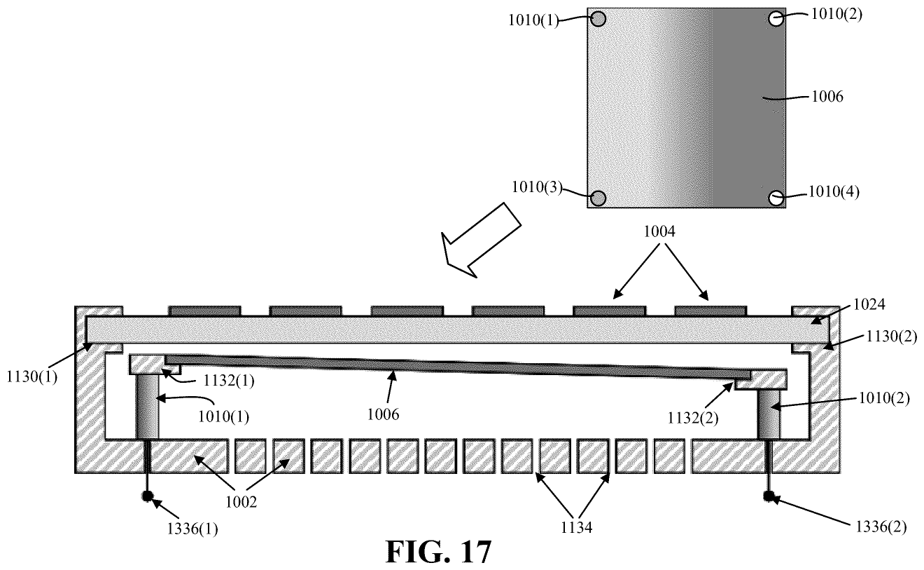

In FIG. 17, the two left actuators 1010(1) and 1010(3) are in the middle state as a result of a slightly low voltage or bias provided thereto, in which the actuator 1010(1) and 1010(3) moves somewhat towards the vertical upper limit, effectively moving the plane from the two left corners. The two right actuators 1010(2) and 1010(4) are in the down state, with no voltage or bias provided, whereby there is a maximum gap between the rightmost side of the ground plane 1106 and the top substrate 1024. This generates a moderate vertical linear gradient profile.

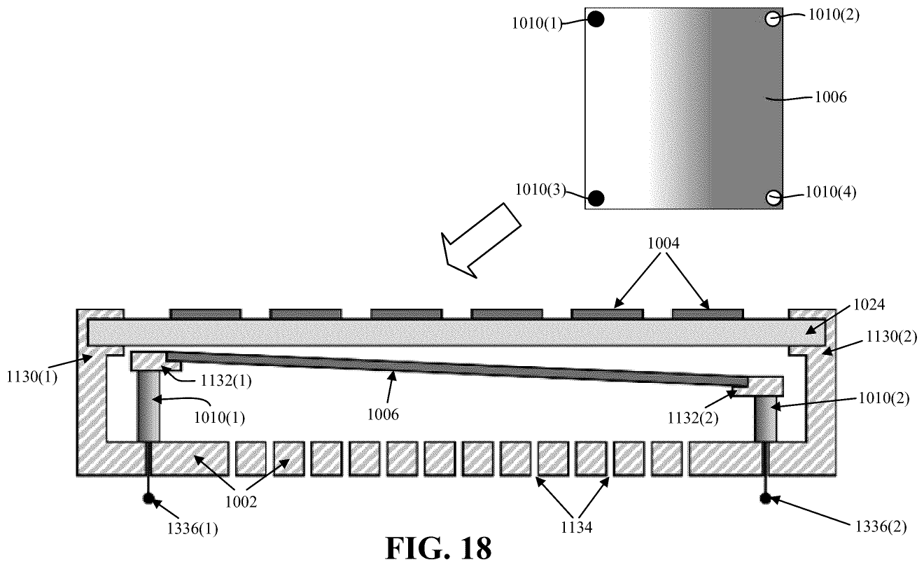

In FIG. 18, the two left actuators 1010(1) and 1010(3) are in the up state as a result of a large voltage or bias provided thereto, in which the actuator 1010(1) and 1010(3) moves very close to (or reaches) the vertical upper limit, effectively moving the plane from the two left corners. The two right actuators 1010(2) and 1010(4) are in the down state, with no voltage or bias provided, whereby there is a maximum gap between the rightmost side of the ground plane 1106 and the top substrate 1024. This steep tilt angle generates a strong vertical linear gradient profile.

Note that once the Piezo motors 1010(1)-1010(4) are in their desired driving positions/stages, no power is needed to hold the motors in the desired phase profile stage; that is, the motors can be driven to a certain stage and the voltage can be taken off to hold the beam direction state, whereby there is static (near-zero) DC power consumption except during motor redriving.

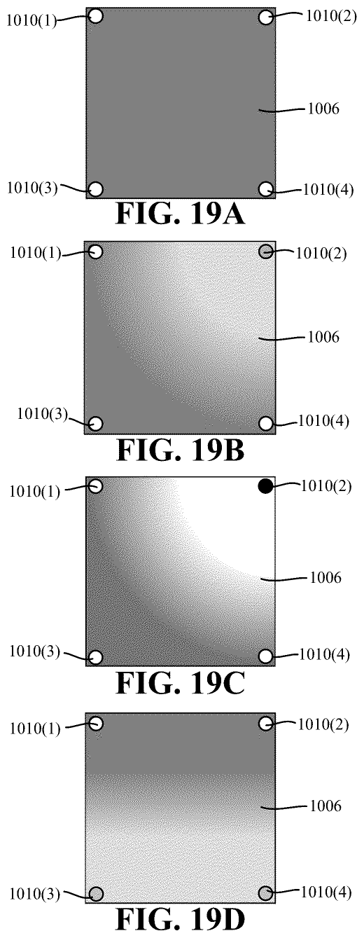

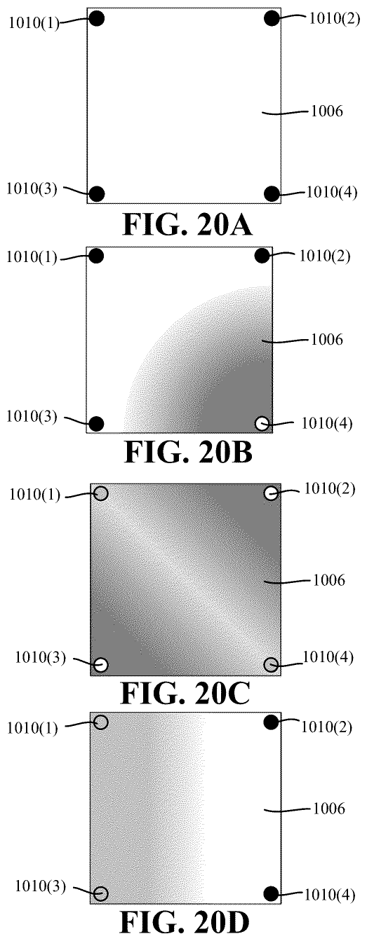

FIGS. 19A-19D and 20A-20D show various gradient profiles achieved by actuating zero or more of the different corner vertical actuators to provide deflection in the ground plane 1006; (FIG. 19A corresponds to the top view in FIG. 16). In these examples, each actuator can be positioned at one of an up, middle or down state. As with FIGS. 16-18, high bias (e.g., corresponding to an “up” state) is represented by a dark shaded dot at zero or more of the corners of the flexible and moveable ground plane sheet 1006, medium bias (e.g., corresponding to a “middle” state) is represented by a lightly-shaded dot at zero or more of the corners of the flexible and moveable ground plane sheet 1006, and zero (or very low) bias (e.g., corresponding to a “down” state) is represented by an unshaded dot at zero or more of the corners of the flexible and moveable ground plane sheet 1006. As can be seen, multiple phase profiles can be achieved by various combinations of actuators in the up state, middle states or down states. Note that analog tuning is achievable, and these are only non-limiting examples of possible vertical positions. Indeed, not only are the maximum down state and maximum up state achievable by any actuator, but virtually any vertical position between the maximum down state and maximum up state are achievable, providing a vast number of phase profiles from which to dynamically select to reconfigure a reconfigurable surface.

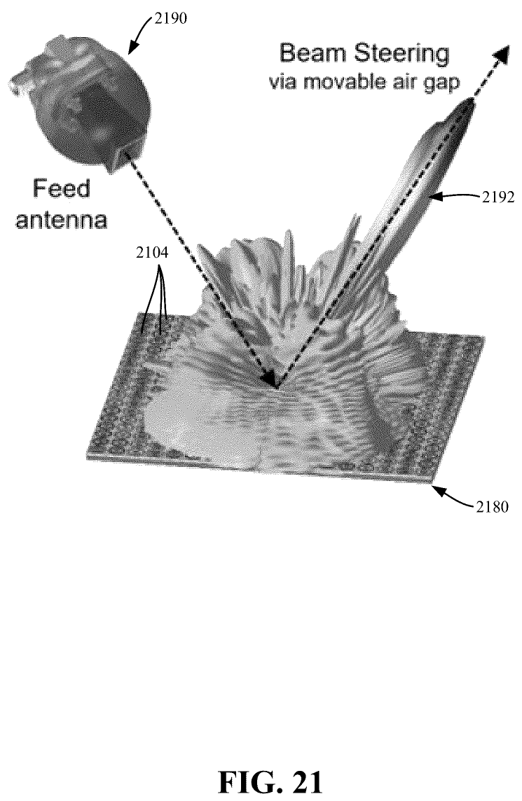

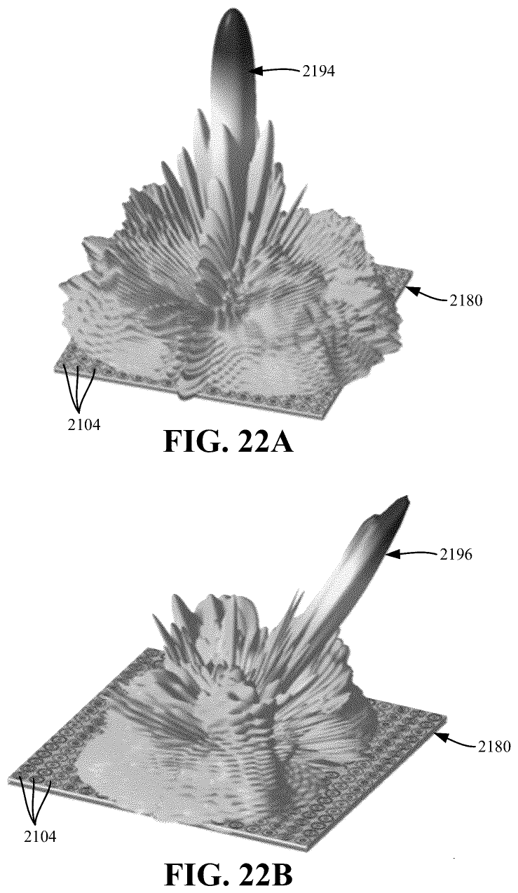

FIGS. 21 and 22A and 22B are depicted examples of when an electromagnetic beam is incident from a nearby access point or base station, and beam steering is achieved by changing the vertical gap between the substrate and the ground plane as described herein. In simulations, the impinging electromagnetic beam was generated from a horn antenna 2190 placed at a certain angle and distance away from the center of a reconfigurable surface (panel) 2180 of arrayed elements 2104 as shown in FIG. 21. The reflected beam 2192 of FIG. 21 has a steering angle comprised of an elevation angle θ and azimuth angle ϕ. By controlling the phase profile of the reconfigurable surface 2180 as described herein, different steering angles result. FIG. 22A shows the simulated response from the reconfigurable surface 2180 for different phase profile scenarios. In FIG. 22A, the reflected beam 2194 is in the direction θ=0° and ϕ=0°, while in FIG. 22B, the reflected beam 2196 is in the direction θ=30° and ϕ=0°.

One or more example embodiments can be embodied in a reconfigurable surface, such as described and represented herein. The reconfigurable surface can include respective metallic resonating elements of respective unit cells located at an upper portion of the reconfigurable surface to reflect an electromagnetic signal impinging on the reconfigurable surface as a reflected beam, a flexible metallic ground plane beneath the respective metallic resonating elements forming respective gaps between respective areas of the flexible ground plane and the respective metallic resonating elements, and a group of actuators controllable to vertically move the flexible ground plane to change respective distances corresponding to the respective gaps between the respective areas of the flexible ground plane and the respective resonating metallic elements. The respective distances determine a phase profile of the reconfigurable surface that is usable to determine a steering direction of the reflected beam. The group of actuators can be electrically coupled to a controller to independently drive the group of actuators to controllably move the flexible ground plane vertically.

The flexible ground plane can include four respective corners, and wherein the group of actuators can include four respective piezo motors mechanically coupled to the four respective corners to independently adjust respective heights of the respective corners.

The respective distances can include first respective distances that correspond to a first amount of curvature in the flexible ground plane, the phase profile can be a first phase profile that determines a first steering direction of the reflected beam, and a controller can drive the group of actuators to vertically move the flexible ground plane to change the first amount of curvature to a second amount of curvature that changes the first respective distances to second respective distances to determine a second phase profile of the reconfigurable surface that determines a second steering direction of the reflected beam.

The respective distances can correspond to a first tilt angle, the phase profile can be a first phase profile that determines a first steering direction of the reflected beam, and a controller can drive the second group of actuators to vertically move the flexible ground plane to change the first tilt angle to a second tilt angle that changes the first phase profile to a second phase profile that determines a second steering direction of the reflected beam.

The respective distances can include first respective distances that correspond to a first amount of curvature and a first tilt angle of the flexible ground plane, the phase profile can be a first phase profile that determines a first steering direction of the reflected beam, and a controller can drive the group of actuators to vertically move the flexible ground plane to change the first amount of curvature to a second amount of curvature, and change the first tilt angle to a second tilt angle, to change the first respective distances to second respective distances to determine a second phase profile of the reconfigurable surface that determines a second steering direction of the reflected beam.

Further embodiments can include comprising a housing that contains the respective metallic resonating elements, the flexible metallic ground plane, and the group of actuators. The housing can include perforations at a lower portion of the housing opposite the upper portion of the reconfigurable surface.

The respective metallic resonating elements can be arranged as a two-dimensional array at the upper portion of the reconfigurable surface, and the respective metallic resonating elements can be configured to resonate at a frequency corresponding to a frequency of the electromagnetic signal impinging on the reconfigurable surface.

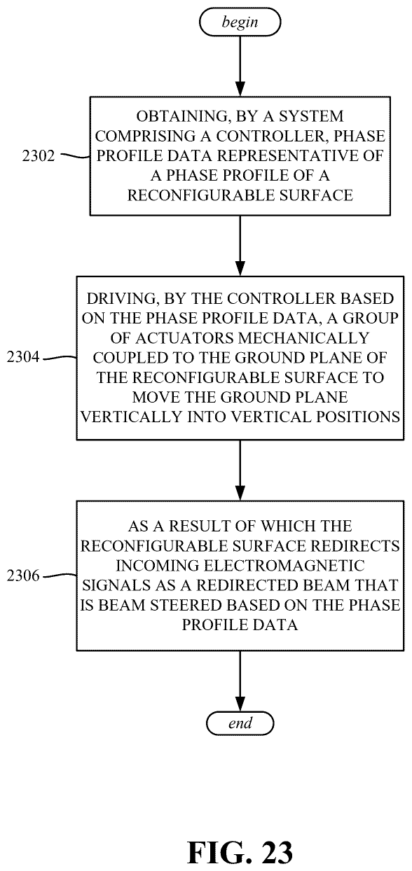

One or more example embodiments, such as corresponding to example operations of a method, are represented in FIG. 23. Example operation 2302 represents obtaining, by a system comprising a controller, phase profile data representative of a phase profile of a reconfigurable surface. Example operation 2304 represents driving, by the controller based on the phase profile data, a group of actuators mechanically coupled to the ground plane of the reconfigurable surface to move the ground plane vertically into vertical positions. As a result of which (block 2306) the reconfigurable surface redirects incoming electromagnetic signals as a redirected beam that is beam steered based on the phase profile data.

The ground plane can include four respective corners, the group of actuators can include four respective motors mechanically coupled to the four respective corners, and the driving by the controller of the second group of actuators can include controlling the four respective motors to drive the four respective corners respective vertical amounts.

The phase profile data can be first phase profile data, wherein the redirected beam can be a first redirected beam including a first beam direction, wherein the vertical positions can be first vertical positions, and further operations can include obtaining, by the system, second phase profile data representative of a second phase profile of the reconfigurable surface, and driving, by the controller based on the second phase profile data, the group of linear actuators to move the ground plane vertically into second vertical positions, to change the first beam direction of the first redirected beam to a second beam direction of the second redirected beam.

The first vertical positions can correspond to a first amount of flex of the ground plane corresponding to a first gradient phase profile, and driving by the controller based on the second phase profile data of the group of linear actuators, can change the first amount of flex to a second amount of flex of the ground plane corresponding to a second gradient phase profile.

The first vertical positions can correspond to a first amount of tilt of the ground plane, and driving, by the controller based on the second phase profile data of the group of linear actuators, can change the first amount of tilt to a second amount of tilt of the ground plane.

The first vertical positions can correspond to a first amount of tilt and a first amount of flex and of the ground plane, the first amount of tilt and the first amount of flex can determine a first gradient phase profile, and driving, by the controller based on the second phase profile data of the group of linear actuators, can change the first amount of tilt and the first amount of flex to a second amount of tilt and a second amount of flex of the ground plane; the second amount of tilt and the second amount of flex can determine a second gradient phase profile.

One or more example embodiments can be embodied in a system, such as described and represented herein. The system can include respective metallic resonating elements of respective unit cells located at an upper portion of a reconfigurable surface, a flexible metallic ground plane adjacent to the respective metallic resonating elements that forms respective gaps between respective portions of the flexible ground plane and the respective metallic resonating elements; and a controller that mechanically moves the flexible metallic ground plane vertically, to determine respective distances between the respective portions of the flexible ground plane and the respective resonating metallic elements. The respective distances determine a direction of a beam reflected by the reconfigurable surface from an electromagnetic signal impinging on the reconfigurable surface.

The controller can mechanically curve the flexible metallic ground plane by driving at least one portion of the flexible metallic ground plane vertically relative to at least one other portion of the flexible metallic ground plane.

The controller can mechanically tilt the flexible metallic ground plane by driving at least one portion of the flexible metallic ground plane vertically relative to at least one other portion of the flexible metallic ground plane.

The flexible metallic ground plane can include four respective corners, and there can be four respective mechanical actuators mechanically coupled to the four respective corners to determine respective relative heights of the four respective corners. The controller can mechanically change at least one of: curve, tilt angle or height of the flexible metallic ground plane by driving the four respective mechanicals motors to move the four respective corners of the flexible metallic ground plane vertically. The four respective mechanical can be beneath the four respective corners to drive the four respective corners respective upward or downward vertical distances relative to one another.

As can be seen, the technology described herein is directed to a beam steering device based on mechanical tuning, such as with only four vertically-oriented linear actuators (which can be piezo motors) per panel, regardless of panel size or number of unit-cells; (this is in contrast to existing mechanisms that have tunable components soldered on each unit-cell, which drives up the cost and fabrication complexity). The technology described herein provides analog-style beam steering capability with only four wires/actuation points per panel instead of quantized states in electronic panels.

As such, an expensive FPGA controller or the like is not needed, as the motors can be controlled using a commercial off-the-shelf microcontroller. This further facilitates low to minimum coding that need only control four actuators, further driving down the software development and debugging costs. The result is low-cost fabrication and no vendor-specific component lock-in requirements.

Indeed, in one implementation, this the technology described herein only is based on having four movable components in total to provide analog-style and beam steering functionality with only four wires/actuation points per panel, avoiding of complex coding requirements. The actuators can be controlled based on look-up table-based tuning using any of the many suitable commercially available microcontrollers, thus needing only negligible compute complexity requirements with integrated power drivers for the motors.

Benefits thus include beam reconfigurability with reduced cost of manufacturing by utilizing a flexible metal sheet to create tilt, flex and/or elevation change using linear actuators. Low-cost fabrication along with no vendor-specific component requirements help reduce the cost. Indeed, among other benefits, the reconfigurability device described herein offers a huge cost reduction when compared to currently available electronic beam manipulation solutions. For example, scaling up other solutions increases exponentially with cost as the number of unit cells increases exponentially, e.g., an 8×8 unit cell device needs components (PIN diodes and/or varactors) and soldering for 64 unit cells, a 16×16 unit cell device needs components and soldering for 256 unit cells, a 32×32 unit cell device needs components and soldering for 1024 unit cells, and so on. For example, a 64×64 unit cell device with PIN diodes and/or varactors can cost almost $12,000 to construct. If a unit-cell requires more than one PIN diode for more tuning states, the cost further exponentially rises. In contrast, one implementation of the technology described herein operates with only four low cost vertical positioning motors regardless of the number of unit cells, whereby a unit cell device based on linear actuators as described herein generally costs substantially less, and the cost does not increase exponentially as the number of unit cells increases exponentially.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A reconfigurable surface, comprising:
respective metallic resonating elements of respective unit cells located at an upper portion of the reconfigurable surface to reflect an electromagnetic signal impinging on the reconfigurable surface as a reflected beam;
a flexible metallic ground plane beneath the respective metallic resonating elements forming respective gaps between respective areas of the flexible ground plane and the respective metallic resonating elements; and
a group of actuators controllable to vertically move the flexible ground plane to change respective distances corresponding to the respective gaps between the respective areas of the flexible ground plane and the respective resonating metallic elements;
wherein the respective distances determine a phase profile of the reconfigurable surface that is usable to determine a steering direction of the reflected beam.

2. The reconfigurable surface of claim 1, wherein the group of actuators is electrically coupled to a controller to independently drive the group of actuators to controllably move the flexible ground plane vertically.

3. The reconfigurable surface of claim 1, wherein the flexible ground plane has four respective corners, and wherein the group of actuators comprises four respective piezo motors mechanically coupled to the four respective corners to independently adjust respective heights of the respective corners.

4. The reconfigurable surface of claim 1, wherein the respective distances comprise first respective distances that correspond to a first amount of curvature in the flexible ground plane, wherein the phase profile is a first phase profile that determines a first steering direction of the reflected beam, and wherein a controller drives the group of actuators to vertically move the flexible ground plane to change the first amount of curvature to a second amount of curvature that changes the first respective distances to second respective distances to determine a second phase profile of the reconfigurable surface that determines a second steering direction of the reflected beam.

5. The reconfigurable surface of claim 1, wherein the respective distances correspond to a first tilt angle, wherein the phase profile is a first phase profile that determines a first steering direction of the reflected beam, and wherein a controller drives the second group of actuators to vertically move the flexible ground plane to change the first tilt angle to a second tilt angle that changes the first phase profile to a second phase profile that determines a second steering direction of the reflected beam.

6. The reconfigurable surface of claim 1, wherein the respective distances comprise first respective distances that correspond to a first amount of curvature and a first tilt angle of the flexible ground plane, wherein the phase profile is a first phase profile that determines a first steering direction of the reflected beam, and wherein a controller drives the group of actuators to vertically move the flexible ground plane to change the first amount of curvature to a second amount of curvature, and change the first tilt angle to a second tilt angle, to change the first respective distances to second respective distances to determine a second phase profile of the reconfigurable surface that determines a second steering direction of the reflected beam.

7. The reconfigurable surface of claim 1, further comprising a housing that contains the respective metallic resonating elements, the flexible metallic ground plane, and the group of actuators.

8. The reconfigurable surface of claim 7, wherein the housing comprises perforations at a lower portion of the housing opposite the upper portion of the reconfigurable surface.

9. The reconfigurable surface of claim 1, wherein the respective metallic resonating elements are arranged as a two-dimensional array at the upper portion of the reconfigurable surface, and wherein the respective metallic resonating elements are configured to resonate at a frequency corresponding to a frequency of the electromagnetic signal impinging on the reconfigurable surface.

10. A method, comprising:
obtaining, by a system comprising a controller, phase profile data representative of a phase profile of a reconfigurable surface; and
driving, by the controller based on the phase profile data, a group of actuators mechanically coupled to the ground plane of the reconfigurable surface to move the ground plane vertically into vertical positions,
as a result of which the reconfigurable surface redirects incoming electromagnetic signals as a redirected beam that is beam steered based on the phase profile data.

11. The method of claim 10, wherein the ground plane comprises four respective corners, wherein the group of actuators comprises four respective motors mechanically coupled to the four respective corners, and wherein the driving by the controller of the second group of actuators comprises controlling the four respective motors to drive the four respective corners respective vertical amounts.

12. The method of claim 10, wherein the phase profile data is first phase profile data, wherein the redirected beam is a first redirected beam comprising a first beam direction, wherein the vertical positions are first vertical positions, and further comprising obtaining, by the system, second phase profile data representative of a second phase profile of the reconfigurable surface, and further comprising driving, by the controller based on the second phase profile data, the group of linear actuators to move the ground plane vertically into second vertical positions, to change the first beam direction of the first redirected beam to a second beam direction of the second redirected beam.

13. The method of claim 12, wherein the first vertical positions correspond to a first amount of flex of the ground plane corresponding to a first gradient phase profile, and wherein the driving, by the controller based on the second phase profile data of the group of linear actuators, changes the first amount of flex to a second amount of flex of the ground plane corresponding to a second gradient phase profile.

14. The method of claim 12, wherein the first vertical positions correspond to a first amount of tilt of the ground plane, and wherein the driving, by the controller based on the second phase profile data of the group of linear actuators, changes the first amount of tilt to a second amount of tilt of the ground plane.

15. The method of claim 12, wherein the first vertical positions correspond to a first amount of tilt and a first amount of flex and of the ground plane, wherein the first amount of tilt and the first amount of flex determine a first gradient phase profile, and wherein the driving, by the controller based on the second phase profile data of the group of linear actuators, changes the first amount of tilt and the first amount of flex to a second amount of tilt and a second amount of flex of the ground plane, wherein the second amount of tilt and the second amount of flex determine a second gradient phase profile.

16. A system, comprising:
respective metallic resonating elements of respective unit cells located at an upper portion of a reconfigurable surface;
a flexible metallic ground plane adjacent to the respective metallic resonating elements that forms respective gaps between respective portions of the flexible ground plane and the respective metallic resonating elements; and
a controller that mechanically moves the flexible metallic ground plane vertically, to determine respective distances between the respective portions of the flexible ground plane and the respective resonating metallic elements,
wherein the respective distances determine a direction of a beam reflected by the reconfigurable surface from an electromagnetic signal impinging on the reconfigurable surface.

17. The system of claim 16, wherein the controller mechanically curves the flexible metallic ground plane by driving at least one portion of the flexible metallic ground plane vertically relative to at least one other portion of the flexible metallic ground plane.

18. The system of claim 16, wherein the controller mechanically tilts the flexible metallic ground plane by driving at least one portion of the flexible metallic ground plane vertically relative to at least one other portion of the flexible metallic ground plane.

19. The system of claim 17, wherein the flexible metallic ground plane comprises four respective corners, and further comprising four respective mechanical actuators mechanically coupled to the four respective corners to determine respective relative heights of the four respective corners, and wherein the controller mechanically changes at least one of: curve, tilt angle or height of the flexible metallic ground plane by driving the four respective mechanicals motors to move the four respective corners of the flexible metallic ground plane vertically.

20. The system of claim 19, wherein the four respective mechanical are beneath the four respective corners to drive the four respective corners respective upward or downward vertical distances relative to one another.
